(19) United States
(12) Patent Application Publication
(10) Pub. No.: US 2009/0161246 A1
(43) Pub. Date: Jun. 25, 2009

(54) Random Number Generation Using Hard Disk Drive Information

(75) Inventors: Zvonimir Bandic, San Jose, CA (US); Satoshi Yamamoto, San Jose, CA (US); Minoru Hashimoto, Fujisawa-shi (JP); Cyril Guyot, San Jose, CA (US); Anand Krishnamurthi Kulkarni, San Jose, CA (US); Marco Sanvido, Belmont, CA (US); Jorge Campello de Souza, Cupertino, CA (US)

Correspondence Address: STEVEN J. CAHILL/ HITACHI GST, P.O. Box 779, MENLO PARK, CA, 94026-0779, US

(73) Assignee: Hitachi Global Storage Technologies Netherlands, B.V., Amsterdam (NL)

(21) Appl. No.: 11/963,837

(22) Filed: Dec. 23, 2007

(51) Int. Cl. G11B 15/18

(52) U.S. Cl. 360/71

(57) ABSTRACT

A hard disk drive enhances random number generation. In particular embodiments, the hard disk drive includes a controller, a hard disk, and a head. The head includes a read sensor for reading patterns on the hard disk. The controller generates a random number based on information associated with the position of the head relative to at least one track of the hard disk.

### CROSS-REFERENCE TO RELATED APPLICATION

This application is related to commonly assigned U.S. patent application Ser. No. ______, (Attorney Docket Number HSJ9-2007-0189-US1), filed concurrently herewith, to Cyril Guyot et al., which is incorporated by reference herein.

### BACKGROUND OF THE INVENTION

The present invention relates to computer systems, and more particularly, to random number generation.

Random numbers have a variety of applications in cryptography, statistics, lotteries, gambling, etc. When generated, random numbers are ideally arbitrary and unpredictable. However, generating truly random numbers is non-trivial.

### BRIEF SUMMARY OF THE INVENTION

The present invention provides techniques for generating random numbers. According to some embodiments of the present invention, a hard disk drive includes a controller, a hard disk, and a head. The head includes a read sensor for reading patterns on the hard disk. The controller generates a random number based on information associated with the position of the head relative to at least one track of the hard disk.

Various objects, features, and advantages of the present invention will become apparent upon consideration of the following detailed description and the accompanying drawings.

### BRIEF DESCRIPTION OF THE DRAWINGS

FIG. 1 is a block diagram that illustrates a host system and a hard disk drive, according to an embodiment of the present invention.

FIG. 2 is a block diagram that illustrates a portion of the hard disk drive of FIG. 1, according to an embodiment of the present invention.

FIG. 3 is a block diagram that illustrates a portion of the hard disk of FIG. 2, including details of a portion of a track, according to an embodiment of the present invention.

### DETAILED DESCRIPTION OF THE INVENTION

Random numbers may be characterized as weak (more predictable) or strong (less predictable) where perfectly random numbers are the strongest. In computing, software programs, referred to as pseudorandom number generators, generate weaker random numbers than hardware random number generators, because pseudorandom number generators are finite state machines. Finite state machines, having a finite number of states, are predictable, and thus cannot produce truly random numbers.

Accordingly, when a user generates random numbers for a given application (e.g., for generating cryptographic keys), the user typically requires a random number seed to initialize a pseudorandom number generator. Without a random number seed, a deterministic algorithm for generating cryptographic keys will generate the same keys.

Accordingly, users often use a hardware random number generator such as a random number generator dongle that is dedicated to generating random numbers. Hardware random number generators exploit physical phenomena such as noise, which has inherent entropy or randomness. The random number generator can convert such noise into a random bit sequence or random number. The generated random number can then be used as a random number seed in a pseudorandom number generator. While dongles may produce stronger random numbers than software random number generators, dongles may be expensive.

Particular embodiments of the present invention provide techniques for generating random numbers. As described in more detail below, in one embodiment, a hard disk drive includes a controller, a hard disk coupled to the controller, and a head coupled to the controller. The controller generates a random number based on information associated with the position of the head relative to at least one track of the hard disk. In a specific embodiment, the controller generates the random number based servo sector information.

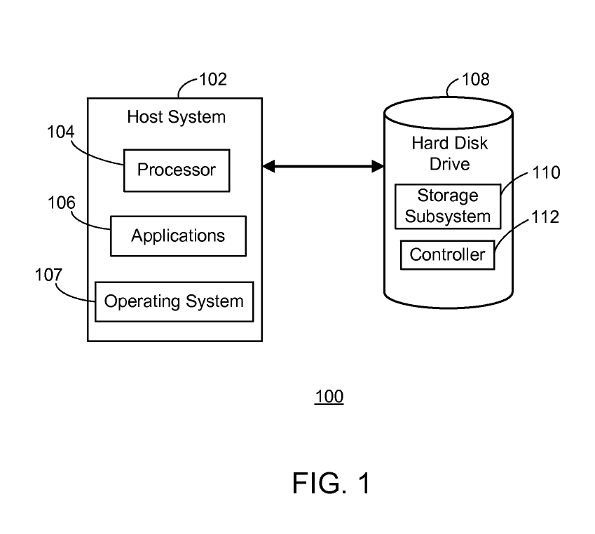

FIG. 1 is a block diagram that illustrates a system 100, according to an embodiment of the present invention. System 100 includes a host system 102. Host system 102 includes a processor 104, applications 106, and an operating system 107. System 100 also includes a hard disk drive 108. Hard disk drive 108 includes a storage subsystem 110 and a controller 112. Host system 102 can be any type of computer system such as an embedded system, a minimalistic system, a hand-held device or computer, etc. Hard disk drive 108 can be a part of the same system as host system 102 or part of a different system, depending on the specific implementation.

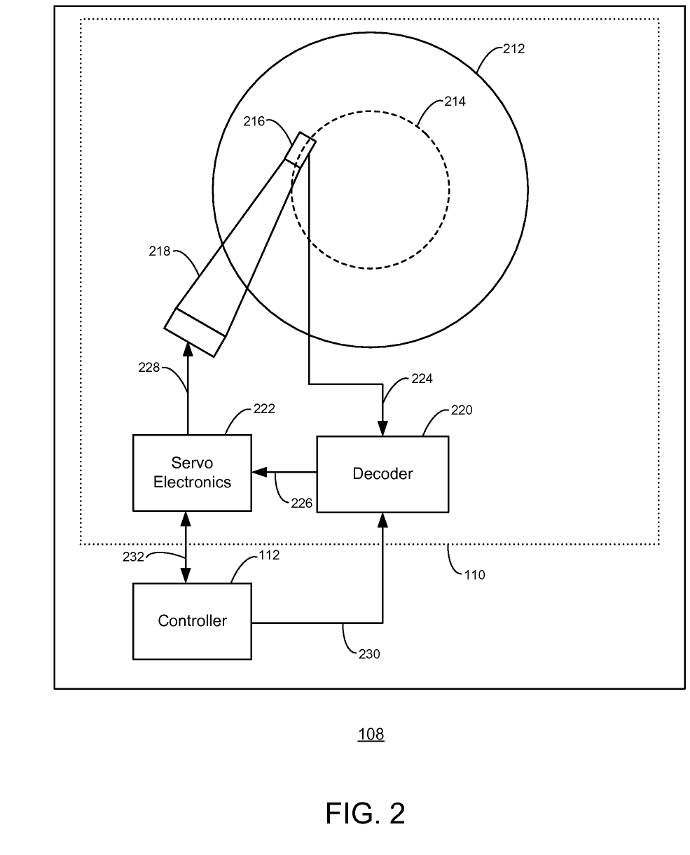

FIG. 2 is a block diagram that illustrates a portion of the hard disk drive 108 of FIG. 1, including details of storage subsystem 110, according to an embodiment of the present invention.

In one embodiment, storage subsystem 110 of hard disk drive 108 includes a magnetic hard disk 212, read/write head 216 (also called a data recording transducer), actuator 218, decoder 220, and servo electronics 222. Hard disk 212 has a set of radially spaced tracks, one of which is shown at track 214. Information is written to and/or read from track 214 by read/write head 216. Read/write head 216 includes a read sensor and a write element. The write element writes magnetic information on disk 212 in response to input electrical signals. The read sensor reads magnetic information recorded on disk 212 and outputs electrical signals representing the magnetic information to decoder 220. Read/write head 216 is connected to actuator 218, which radially positions head 216 over a selected track.

Read/write head 216 is connected to decoder 220, as indicated by line 224. As track 214 passes under read/write head 216, the read/write head 216 encounters servo sectors and data sectors. Decoder 220 receives a bit stream from the read sensor corresponding to the bit stream recorded on track 214, and functions to detect the servo timing mark (STM) bit pattern in the servo sectors as they pass under read/write head 216. The STM is a fixed vector that helps synchronize the information that follows it. The servo information, such as the track identification (TID) and the servo sector identification, typically follows the STM.

Upon identification of a STM bit pattern, decoder 220 transmits an “STM found” signal to servo electronics 222, as schematically indicated by line 226 in FIG. 2. Servo electronics 222 also receives servo information from decoder 220, and makes use of the servo information, gated by the “STM found” signal, to perform closed loop control of actuator 218, schematically indicated by line 228, such that read/write head 216 is centered over a desired track (i.e., track 214 in this example).

Controller 112 is coupled to decoder 220 and to servo electronics 222 as indicated by lines 230 and 232, respectively. In operation, controller 112 controls the operations of storage subsystem 110, including decoder 220 and servo electronics 222. Controller 112 also communicates with the host system 102 (FIG. 1) to exchange control information and data (e.g., commands to generate random numbers, resulting random numbers, etc.). Operations of hard disk drive 108 are described in more detail below.

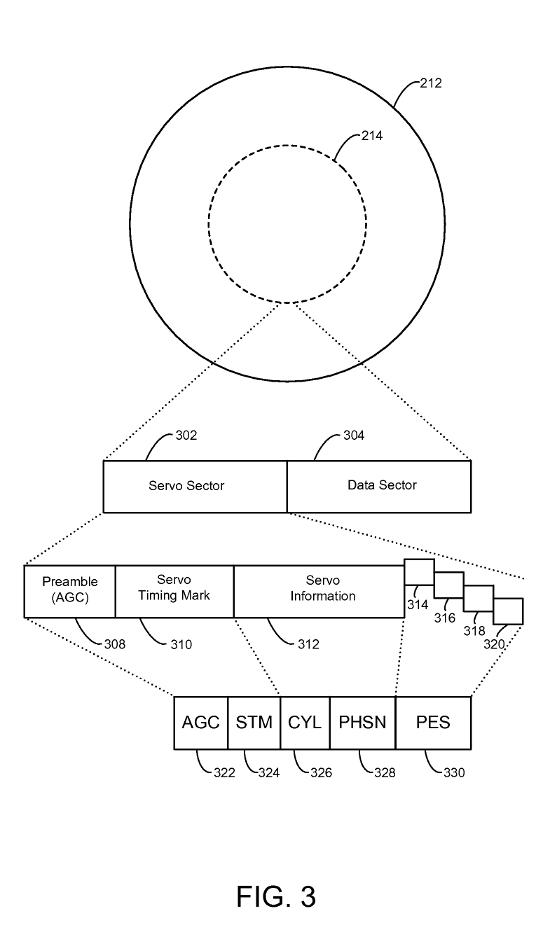

FIG. 3 is a block diagram that illustrates a portion of the magnetic hard disk 212 of FIG. 2, including details of a portion of track 214, according to an embodiment of the present invention. Track 214 includes servo sectors interspersed with data sectors. For ease of illustration, only one servo sector 302 and one data sector 304 are shown from track 214. The actual number of servo sectors and data sectors on a given track depends on the particular implementation. FIG. 3 also shows a more detailed view of servo sector 302. In one embodiment, servo sector 302 includes a preamble bit pattern 308, a servo timing mark (STM) 310, and servo information 312, where read/write head 216 encounters regions 308, 310, 312 in that order. The servo information 312 includes an index bit, according to particular embodiments of the present invention.

In one embodiment, servo sector 302 also includes servo bursts 314, 316, 318, and 320. Servo bursts 314, 316, 318, and 320 are positioned at predefined offsets from each other relative to the centerline of track 214. The specific configuration of servo bursts 314, 316, 318, and 320 depends on the particular implementation. As read/write head 216 reads the servo bursts, the servo bursts facilitate controller 112 (FIG. 2) in determining the position of the read/write head 216 relative to the centerline of track 214.

In one embodiment, the servo information 312 includes a servo pattern, which is a pre-written analog pattern used to control the position of read/write head 216. As FIG. 3 shows, the servo sector 302 includes an automatic gain control portion (AGC) 322 in preamble 308, servo timing mark (STM) 324, cylinder code portion (CYL) 326, physical head sector number portion (PHSN) 328, and position error signal portion (PES) 330. In one embodiment, AGC 322 is used by the drive controller 112 to decide how much read/write head 216 needs to amplify or adjust the gain of the signal generated by the read sensor such that read/write head 216 reads the data from a sector at the same current level as the other sectors. By adjusting the gain to an appropriate level, head 216 is able to read data from track 214 correctly. STM 324 identifies the correct timing. STM 324 corresponds to servo timing mark 310. CYL 326 indicates the radial position and track width to ensure that read/write head 216 is over the correct servo sector 302. PES 330 indicates a measurement of fine position within one track width to ensure that read/write head 216 is in the center of track 214. A position error signal is generated using the servo bursts 314, 316, 318, and 320 in PES portion 330.

### Random Number Generation

In one embodiment, the hard disk drive 108 generates a random number based on the servo information 312. As indicated above, the servo information 312 provides information associated with the position of read/write head 216 relative to a given track of hard disk 212. In one embodiment, controller 112 of hard disk drive 108 performs operations described herein, including performing calculations to generate random numbers. In one embodiment, hard disk drive 108 generates a random number based on the difference between position information of the read/write head 216 at different locations on a track of disk 212, where the position information is derived from reading servo information in one or more servo sectors.

In one embodiment, controller 112 generates a random number based on a value that is derived from the servo sector 302, where the servo sector 302 can be any value or combination of values provided by servo portions 308, 310, and 312, or based on any value that is derived from these values or a combination thereof. For example, in one embodiment, controller 112 of hard disk drive 108 generates a random number based on the automatic gain control value read from AGC 322 in servo sector 302 by the read sensor in head 216.

In one embodiment, the controller 112 calculates an accumulated automatic gain control value by integrating the signal received while reading the AGC 322 part of the servo region. Because both the position of read/write head 216 and the initial strength of the writing vary randomly from one sector to another, the lowest order bits of this automatic gain control value are expected to be unpredictable, and are thus uniformly distributed. If the position of read/write head 216 is closer to the middle of track 214, read/write head 216 detects a higher current when reading the automatic gain control value from an AGC portion 322. Conversely, if the position of read/write head 216 is farther from the middle of track 214, read/write head 216 detects a lower current when reading the automatic gain control value from an AGC portion 322. The calculated automatic gain control value is different every time read/write head 216 passes over a sector. As such, the least significant digits of the automatic gain control value continuously vary for each calculation. Furthermore, different calculations for the same servo sector 302 vary each time the servo sector is read, because the position of read/write head 216 relative to the center of track 214 varies each time the servo sector is read by the read sensor.

In one embodiment, controller 112 generates a random number based on the most recent automatic gain control value read from AGC 322. In another embodiment, controller 112 calculates an aggregated value based on automatic gain control information. For example, in one embodiment, controller 112 aggregates the most recent automatic gain control value read by the read sensor and one or more past automatic gain control values read by the read sensor prior to the most recent automatic gain control value. Controller 112 then calculates a random number based on the aggregate of multiple automatic gain control values read from servo sectors on the hard disk. In one embodiment, if a given random number is based on an aggregate of automatic gain control values (e.g., historical values), controller 112 biases the calculated random number by giving more weight to automatic gain control information that was more recently read by the read sensor from the hard disk (e.g., more recent AGC values). Again, such calculations can be based on the gain value of AGC 322, on a value of any of the other portions 324, 326, 328, and 330 of servo sector 302, or any combination thereof.

According to another embodiment, controller 112 generates a random number based on reading the servo burst patterns 314, 316, 318, and 320 from one or more servo sectors 302 using the read sensor in head 216.

In one embodiment, to generate a given random number, controller 112 calculates a sufficient number of random bits for the random number such that each successive bit does not correlate with the previously calculated bits. In one embodiment, controller 112 omits calculated bits from the random number that exhibit some cross-correlation with the previously calculated bits. In another embodiment, a Chi-Square statistical test is performed on the generated bits of the random number to validate the assumption of uniformity of the distribution of the bits. In yet another embodiment, the byte entropy of the generated bit stream of the random number can also be calculated to validate that the bit stream is uniformly distributed.

### Pseudorandom Number Generator

In one embodiment, hard disk drive 108 processes a random number generated using information from servo sector 302 in a pseudorandom number generator. In one embodiment, controller 112 functions as the pseudorandom number generator. For example, controller 112 can feed a random number (e.g., a random number seed generated using servo information 312) into a mathematical algorithm, which performs a function such as a hash function to extend one truly random seed into a larger number of pseudorandom bits. This process may also qualify a given random number for certification, such as Federal Information Processing Standards (FIPS), where processing the random number through a pseudorandom number generator may be required.

The foregoing description of the exemplary embodiments of the present invention has been presented for the purposes of illustration and description and is not intended to be exhaustive or to limit the scope of the present invention to the precise form disclosed. For example, embodiments of the present invention can be implemented using one or a combination of hardware, software, and a computer-readable medium containing program instructions. Software implemented by embodiments of the present invention and results of the present invention can be stored on a computer-readable medium such as memory, hard disk drive, compact disc (CD), digital video disc (DVD), or other media. Results of the present invention can be used for various purposes such as being executed or processed by a processor, being displayed to a user, transmitted in a signal over a network, etc. A latitude of modification, various changes, and substitutions are intended in the present invention. In some instances, features of the present invention can be employed without a corresponding use of other features as set forth. Many modifications and variations are possible in light of the above teachings, without departing from the scope of the present invention.

What is claimed is:

1. A hard disk drive for enhancing random number generation, the hard disk drive comprising:
a controller;
a hard disk; and
a head comprising a read sensor for reading patterns on the hard disk, wherein the controller generates a random number based on information associated with a position of the head relative to at least one track of the hard disk.

2. The hard disk drive defined in claim 1 wherein the controller generates the random number based on servo information.

3. The hard disk drive defined in claim 1 wherein the controller generates the random number based on automatic gain control information read from a servo sector on the hard disk.

4. The hard disk drive defined in claim 1 wherein the controller:
calculates an aggregated value based on automatic gain control information read by the head from servo sectors on the hard disk; and
calculates the random number based on the aggregated value.

5. The hard disk drive defined in claim 4 wherein the controller biases the calculated random number by giving more weight to more recent automatic gain control information.

6. The hard disk drive defined in claim 1 wherein the controller calculates a number of bits for the random number such that each successive bit does not correlate with the previously calculated bits.

7. The hard disk drive defined in claim 1 wherein the controller omits calculated bits from the random number that exhibit some cross-correlation with previously calculated bits of the random number.

8. The hard disk drive defined in claim 1 wherein the controller generates the random number based on servo burst patterns read from a servo sector by the read sensor.

9. A computer system that comprises code for enhancing random number generation in a hard disk drive, wherein the code is stored on a computer readable medium, the computer system comprising:
code for determining information associated with a position of a head in the hard disk drive relative to at least one track of a hard disk in the hard disk drive, wherein the head comprises a read sensor; and
code for generating a random number based on the information.

10. The computer system defined in claim 9 wherein the code for generating the random number based on the information further comprises code for generating the random number based on servo information read by the head.

11. The computer system defined in claim 9 wherein the code for generating the random number based on the information further comprises code for generating the random number based on automatic gain control information read by the head from a servo sector.

12. The computer system defined in claim 9 wherein the code for generating the random number based on the information further comprises:
code for calculating an aggregated value based on automatic gain control information read by the head from servo sectors on the hard disk; and
code for calculating the random number based on the aggregated value.

13. The computer system defined in claim 12 wherein the code for generating the random number further comprises code for biasing the calculated random number by giving more weight to automatic gain control information that was more recently read by the head from the hard disk.

14. The computer system defined in claim 9 wherein the code for generating the random number based on the information further comprises code for calculating a number of bits for the random number such that each successive bit does not correlate with the previously calculated bits.

15. The computer system defined in claim 9 wherein the code for generating the random number based on the information further comprises code for omitting calculated bits from the random number that exhibit some cross-correlation with previously calculated bits of the random number.

16. A method for enhancing random number generation in a hard disk drive, the method comprising:
determining information from a servo sector indicating a position of a head in the hard disk drive relative to at least one track of a hard disk, wherein the head comprises a read sensor; and
generating a random number based on the information.

17. The method defined in claim 16 wherein generating the random number based on the information further comprises generating the random number based on servo information in the servo sector.

18. The method defined in claim 16 wherein the generating the random number based on the information further comprises generating the random number based on automatic gain control information read from the servo sector by the head.

19. The method defined in claim 16 wherein generating the random number based on the information further comprises:
calculating an aggregated value based on automatic gain control information read by the head from servo sectors on the hard disk; and
calculating the random number based on the aggregated value.

20. The method defined in claim 16 wherein generating the random number further comprises calculating a number of bits for the random number such that each successive bit does not correlate with the previously calculated bits.

21. The method defined in claim 16 wherein generating the random number further comprises omitting calculated bits from the random number that exhibit some cross-correlation with previously calculated bits of the random number.

22. The method defined in claim 16 wherein determining the information from the servo sector indicating the position of the head in the hard disk drive relative to at least one track of the hard disk further comprises determining the information using servo burst patterns read from the servo sector by the read sensor.
